(19) United States
(12) Patent Application Publication
(10) Pub. No.: US 2009/0007374 A1
(43) Pub. Date: Jan. 8, 2009

(54) HINGE MECHANISM FOR A DISHWASHER, AND ASSOCIATED METHOD

(75) Inventors: Ronald G. Tynes, Hendersonville, TN (US); Torkel Kristensson, Zirndorf (DE); John Helgesen, Rock Hill, SC (US); Gregory A. Meyer, Batesville, IN (US); Gregory Ward, Muscle Shoals, AL (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Electrolux Home Products, Inc.

(21) Appl. No.: 12/024,372

(22) Filed: Feb. 1, 2008

Related U.S. Application Data
(60) Provisional application No. 60/888,474, filed on Feb. 6, 2007.

(51) Int. Cl. E05D 11/00

(52) U.S. Cl. 16/223

(57) ABSTRACT

A dishwasher is provided, comprising a tub member defining an opening and a door member configured to operably engage the tub member so as to cover the opening. A hinge portion is operably engaged with each of the tub member and the door member, wherein the respective hinge portions are pivotably secured together by a hinge pin so as to pivot about a substantially horizontal hinge axis. The door member hinge portion is over-center biased by a biasing member. A friction-reducing bushing is operably engaged with the hinge pin so as to isolate the hinge pin from direct contact with the door member hinge portion when the hinge portions are secured together. An associated method is also provided.

### CROSS-REFERENCE TO RELATED APPLICATIONS

This application claims the benefit of U.S. Provisional Application No. 60/888,474, filed Feb. 6, 2007, the contents of which are incorporated herein by reference.

### BACKGROUND OF THE INVENTION

1. Field of the Invention

Embodiments of the present invention relate to dishwashers and, more particularly, to a hinge mechanism for a dishwasher, and a method associated therewith.

2. Description of Related Art

A dishwasher typically includes a wash tub for containing the dishware to be washed, wherein the tub defines a front opening. The front opening is configured to be engaged by a door for closing/sealing the front opening. The door is typically hinged at the lower end thereof such that the upper end of the door can be pivoted downward so as to permit access to the interior of the tub. The hinge mechanism engaged between the door and the tub (and/or the structure supporting the same) includes two hinge members. One hinge member is connected to the door (or can be the door itself), and the other hinge member is connected to the tub/support structure (or can be the tub/support structure itself). The two hinge members are further joined together by and pivot about a hinge pin.

Typically, the two hinge members and the hinge pin are each formed of a metal, such that the hinge mechanism includes a metal-to-metal contact between the pivoting components. In such instances, the metal-to-metal contact may be between the hinge portions, or between either of the hinge portions and the hinge pin. However, such a metal-to-metal contact may, for example, result in a relatively rough operation of the hinge (which may be manifest as a “rough feel” in the operation of the hinge), a relatively high friction between the pivoting components, and/or a relatively noisy operation. Accordingly, an improved hinge between the door and the tub of a dishwasher would be desirable.

### BRIEF SUMMARY OF THE INVENTION

The above and other needs are met by the present invention which, in one embodiment, provides a dishwasher, comprising a tub member defining an opening and a door member configured to operably engage the tub member so as to cover the opening. A hinge portion is operably engaged with each of the tub member and the door member, wherein the respective hinge portions are pivotably secured together by a hinge pin so as to pivot about a substantially horizontal hinge axis. The door member hinge portion is over-center biased by a biasing member. A friction-reducing bushing is operably engaged with the hinge pin so as to isolate the hinge pin from direct contact with the door member hinge portion when the hinge portions are secured together.

Another aspect of the present invention comprises a method of engaging a tub member with a door member in a dishwasher, wherein the tub member defines an opening, and the door member is configured to operably engage the tub member so as to cover the opening. Such a method comprises pivotably securing together a first hinge portion operably engaged with the tub member and a second hinge portion operably engaged with the door member with a hinge pin, such that the hinge portions pivot about a substantially horizontal hinge axis. The second hinge portion is over-center biased with a biasing member. A friction-reducing bushing is operably engaged with the hinge pin when the first and second hinge portions are secured together so as to isolate the hinge pin from direct contact with the second hinge portion.

Aspects of the present invention thus provide significant advantages as further detailed herein.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 schematically illustrates an exploded view of a hinge mechanism according to one embodiment of the present invention; and

FIG. 2 schematically illustrates a magnified exploded view of a hinge mechanism according to one embodiment of the present invention as shown in FIG. 1.

### DETAILED DESCRIPTION OF THE INVENTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

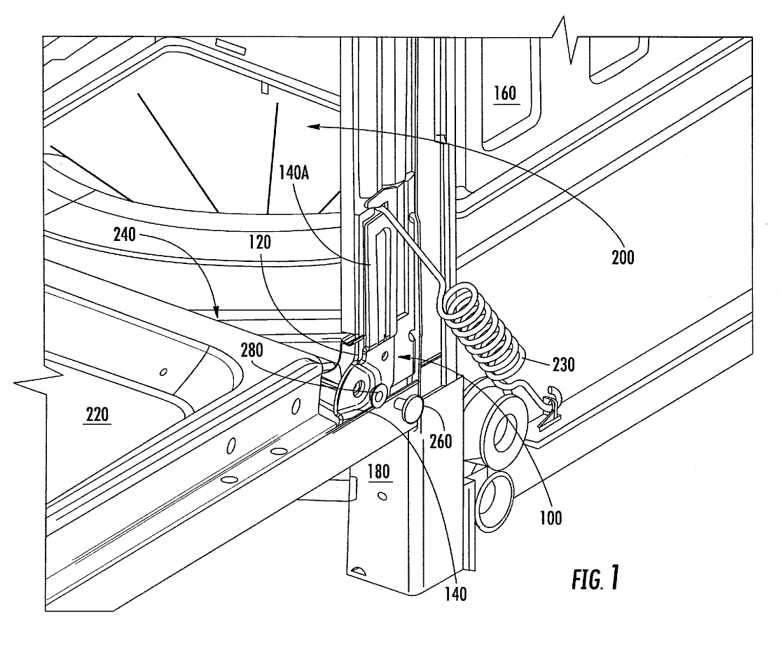

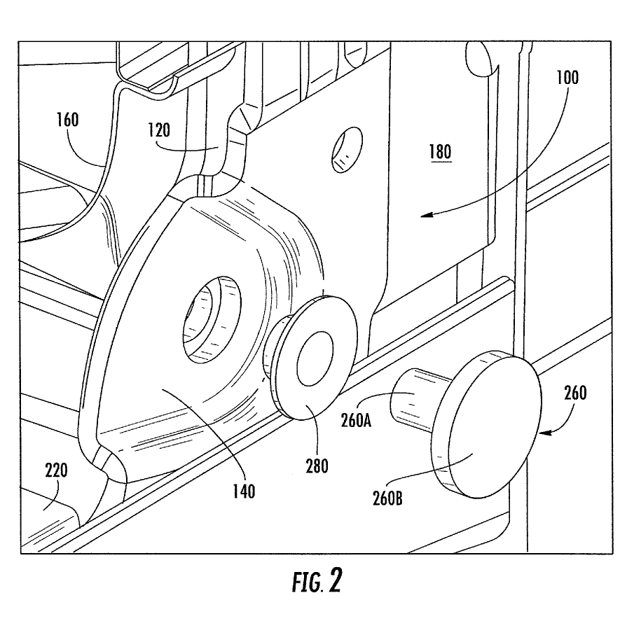

FIGS. 1 and 2 illustrate a hinge mechanism according to one embodiment of the present invention, the hinge mechanism being generally indicated by the numeral 100. Such a hinge mechanism 100 includes a first hinge portion 120 and a second hinge portion 140. The first hinge portion 120 may comprise a member operably engaged with the tub 160 of a dishwasher device, either directly or via a frame 180 disposed about the access opening 200 defined by the tub 160. In some instances, the first hinge portion 120 may be a portion of the tub 160 and/or a portion of the frame 180. Similarly, the second hinge portion 140 may comprise a member operably engaged with the door 220 of the dishwasher device, or may be a portion of the door 220. The first and second hinge portions 120, 140 are configured to be operably engaged so as to be capable of pivoting with respect to each other. As such, where the door 220 is configured to be hinged or pivoted about the lower end 240 thereof (i.e., about a substantially horizontal pivot axis) with respect to the tub 160 and/or the frame 180, a hinge mechanism 100 may be provided about laterally opposing edges of the door 220 so as to allow the door 220 to pivot with respect to and be capable of engaging the tub 160 such that the door 220 seals the access opening 200. In such a configuration, the second hinge portion 140 may be further configured to be over-the-center biased by a biasing member 230, which in some instances may be a spring, operably engaged between the tub 160/frame 180 and an extension 140A of the second hinge portion 140, such that the door 220 is stable in the fully-open position and the substantially-closed position.

In order to provide the pivoting engagement between the first and second hinge portions 120, 140, a hinge pin 260 or other suitable pivot member may be operably engaged therebetween. For example, the hinge pin 260 may be provided in the form of a rivet, but generally includes a shaft portion 260A extending from a head portion 260B. In some prior art dishwasher hinge mechanisms, both hinge portions, as well as the hinge pin, are comprised of a metallic material. As such, those prior art hinge mechanisms may be characterized, for example, by relatively high friction between such components, relatively noisy and/or rough operation, and a less-than-robust tactile function. Accordingly, embodiments of the present invention implement a bushing member 280 configured to operably engage the hinge pin 260 used to pivotably engage the first and second hinge portions 120, 140. In such instances, the bushing member 280 may be configured to axially extend at least partially along the shaft portion 260A of the hinge pin 260, and radially outward from the shaft portion 260A along the head portion 260B of the hinge pin 260. The bushing member 280, thus configured, isolates the shaft portion 260A of the hinge pin 260 from direct contact with at least the second hinge portion 140 and, in some instances, both of the first and second hinge portions 120, 140 (i.e., the shaft portion 260A of the hinge pin 260 is isolated from contact with the pin bores defined by the first and second hinge portions 120, 140 by the bushing member 280). Further, the bushing member 280 isolates the head portion 260B of the hinge pin 260 from direct contact with the first hinge portion 120 or the second hinge portion 140, with whichever the head portion 260B is configured to bear against (i.e., the head portion 260B of the hinge pin 260 being isolated from the second hinge portion 140 by the bushing member 280, as shown in FIGS. 1 and 2).

In some embodiments, the bushing member 280 may be comprised, for example, of a non-metallic material, such as a polymeric material. However, the bushing member 280 may be comprised of any suitable material, whether metallic (i.e., a brass material), non-metallic (i.e., a ceramic material), or a combination thereof (i.e., a polymer-coated metallic material). In any instance, the bushing member 280 thus disposed between the pivoting components (i.e., between the shaft portion 260A of the hinge pin 260 and at least one the second hinge portion 140, if not both of the first and second hinge portions 120, 140, or between the head portion 260B of the hinge pin 260 and the second hinge portion 140) provides a hinge mechanism 100 with lower friction between the pivoting components, a smoother and/or more tactile function, and/or a less noisy operation.

Many modifications and other embodiments of the inventions set forth herein will come to mind to one skilled in the art to which these inventions pertain having the benefit of the teachings presented in the foregoing descriptions and the associated drawings. For example, in some embodiments, a washer member (not shown) may be disposed between the first and second hinge portions 120, 140, and about the shaft portion 260A of the hinge pin 260, so as to provide further isolation of the first hinge portion 120 from the second hinge portion 140, as both pivot with respect to each other. Such a washer member may be comprised of a metallic material, a non-metallic material, or combinations thereof, as necessary or desired for the particular application. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A dishwasher, comprising:
a tub member defining an opening;
a door member configured to operably engage the tub member so as to cover the opening;
a first hinge portion operably engaged with the tub member;
a second hinge portion operably engaged with the door member, the first and second hinge portions being pivotably secured together by a hinge pin so as to pivot with respect to each other about a substantially horizontal hinge axis, and the second hinge portion being over-center biased by a biasing member; and
a friction-reducing bushing operably engaged with the hinge pin so as to isolate the hinge pin from direct contact with the second hinge portion when the first and second hinge portions are secured together.

2. A dishwasher according to claim 1, wherein the hinge pin comprises a shaft portion extending from a head portion, and wherein the first and second hinge portions define respective alignable pin bores configured to receive the shaft portion of the hinge pin for pivotably securing the first and second hinge portions together.

3. A dishwasher according to claim 2, wherein the friction-reducing bushing is configured to axially extend at least partially along the shaft portion of the hinge pin, and radially outward of the shaft portion along the head portion of the hinge pin when operably engaged therewith, thereby isolating at least the second hinge portion from contact with the hinge pin.

4. A dishwasher according to claim 1, wherein the friction-reducing bushing comprises at least one of a metallic material, a non-metallic material, and combinations thereof.

5. A dishwasher according to claim 1, further comprising a washer member disposed between the first and second hinge portions, the washer member defining a pin bore configured to receive the shaft portion of the hinge pin when the first and second hinge portions are pivotably secured together, the washer member thereby separating the first hinge portion from the second hinge portion so as to prevent contact therebetween.

6. A dishwasher according to claim 1, wherein the biasing member comprises a spring element configured to be operably engaged between the tub member and the second hinge portion.

7. A method of engaging a tub member with a door member in a dishwasher, the tub member defining an opening, and the door member being configured to operably engage the tub member so as to cover the opening, the method comprising:
pivotably securing together a first hinge portion operably engaged with the tub member and a second hinge portion operably engaged with the door member with a hinge pin such that the first and second hinge portions pivot about a substantially horizontal hinge axis;
over-center biasing the second hinge portion with a biasing member; and
operably engaging a friction-reducing bushing with the hinge pin when the first and second hinge portions are secured together so as to isolate the hinge pin from direct contact with the second hinge portion.

8. A method according to claim 7, wherein the hinge pin comprises a shaft portion extending from a head portion, and operably engaging a friction-reducing bushing with the hinge pin further comprises operably engaging the friction-reducing bushing with the shaft portion of the hinge pin such that the friction-reducing bushing axially extends at least partially along the shaft portion, and radially outward of the shaft portion along the head portion, when operably engaged with the hinge pin, thereby isolating at least the second hinge portion from contact with the hinge pin when the first and second hinge portions are secured together.

9. A method according to claim 7, further comprising disposing a washer member between the first and second hinge portions, the washer member defining a pin bore configured to receive the shaft portion of the hinge pin when the first and second hinge portions are pivotably secured together, the washer member thereby separating the first hinge portion from the second hinge portion so as to prevent contact therebetween.
